(19) United States
(12) Patent Application Publication
(10) Pub. No.: US 2015/0294225 A1
(43) Pub. Date: Oct. 15, 2015

(54) RECIPE INFORMATION PROCESSING APPARATUS, COOKING APPARATUS, AND RECIPE INFORMATION PROCESSING METHOD

(71) Applicant: Panasonic Intellectual Property Management Co., Ltd., Osaka (JP)

(72) Inventors: ICHIRO TAKEI, Tokyo (JP); HIROYUKI KAYAMA, Osaka (JP)

(21) Appl. No.: 14/675,881

(22) Filed: Apr. 1, 2015

(30) Foreign Application Priority Data
Apr. 11, 2014 (JP) 2014-082031

(51) Int. Cl. G06N 5/04

(52) U.S. Cl. CPC G06N 5/04

(57) ABSTRACT

A cooking apparatus includes a recipe obtaining unit that obtains recipe information for a dish, a preference obtaining unit that obtains preference information for a user, and a recipe modification unit that, based on the obtained preference information, modifies a value of a cooking parameter, which defines a manner of cooking, to provide modified recipe information, the cooking parameter value being included in the obtained recipe information. The preference information is, for example, information indicating taste preference of the user. In that case, the recipe modification unit modifies the cooking parameter value in a direction in which the taste of the dish is more closely fit to the taste preference indicated by the preference information.

### BACKGROUND

1. Technical Field

The present disclosure relates to a recipe information processing apparatus, a cooking apparatus, and a recipe information processing method, each processing recipe information for a dish.

2. Description of the Related Art

Recently, information related to recipes for dishes and prepared in the form of electronic data (hereinafter referred to as “recipe information”) has been utilized widely. For example, Japanese Unexamined Patent Application Publication No. 2007-282700 discloses a cooking apparatus that accepts selection of recipe information prepared for each sort of dish in advance, and that performs, for example, stirring of materials, adjustment of a time, a temperature, and a pressure for cooking, in accordance with the selected recipe information. The desired dish can be readily cooked by employing such related art.

### SUMMARY

Partialities for states of dishes, including tastes, smells, textures, temperatures, and colors (hereinafter referred to as “preference”) are different depending on persons. Accordingly, the cooked dish is desirably as possible as fit to the preference of a person who is going to eat the cooked dish (hereinafter referred to as a “user”).

However, the related art shows the state of the dish cooked in accordance with the same recipe information is basically the same in any cases and is not fitted to the preference of the user in some cases. On the other hand, a possibility of providing the dish fitter to the preference of the user is increased by preparing a larger number of kinds of recipe information for the same sort of dish, such as by preparing a recipe for cooking the dish with a sweetish taste and a recipe for cooking the dish with a salty taste. It is, however, difficult to determine which one is most fit among the many kinds of recipe information. In other words, the related art has a difficulty in providing the dish fit to the preference of the user.

One non-limiting and exemplary embodiment provides a dish fit to the preference of a user.

In one general aspect, the techniques disclosed here feature a recipe information processing apparatus including a recipe obtaining unit that obtains recipe information for a dish, a preference obtaining unit that obtains preference information of a user, and a recipe modification unit that, based on the obtained preference information, modifies a value of a cooking parameter, which defines a manner of cooking, to provide modified recipe information, the cooking parameter value being included in the obtained recipe information.

The present disclosure shows the dish fit to the preference of the user can be provided.

It should be noted that general or specific embodiments may be implemented as a system, a method, an integrated circuit, a computer program, a computer-readable storage medium, or any selective combination thereof. The computer-readable storage medium includes, for example, a nonvolatile storage medium such as a CD-ROM (Compact Disc—Read Only Memory).

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a block diagram of a cooking apparatus according to a first embodiment of the present disclosure;

FIG. 2 illustrates one example of material taste information in the first embodiment of the present disclosure;

FIG. 3 is a graph to explain a dish category in the first embodiment of the present disclosure;

FIG. 4 is a flowchart illustrating one example of operation of the cooking apparatus according to the first embodiment of the present disclosure;

FIG. 5 illustrates examples of preference information and a target taste change rate vector in the first embodiment of the present disclosure;

FIG. 6 is a graph to explain a relationship among various vectors in the first embodiment of the present disclosure;

FIG. 7 is a block diagram of a cooking apparatus according to a second embodiment of the present disclosure;

FIG. 8 is a graph to explain a relationship between a heating time and fragrance in the second embodiment of the present disclosure;

FIG. 9 is a flowchart illustrating one example of operation of the cooking apparatus according to the second embodiment of the present disclosure; and

FIG. 10 illustrates examples of preference information and a target taste change rate vector in the second embodiment of the present disclosure.

### DETAILED DESCRIPTION

### First Embodiment

A first embodiment will be described in detail below with reference to the drawings. A cooking apparatus according to the first embodiment is, for example, a microwave oven, an IH (Induction Heating) cooking heater, or an apparatus having the functions of the formers in a combined manner, each of which includes a user interface such as a touch panel display.

### <Configuration of Cooking Apparatus>

A configuration of the cooking apparatus according to the first embodiment is first described.

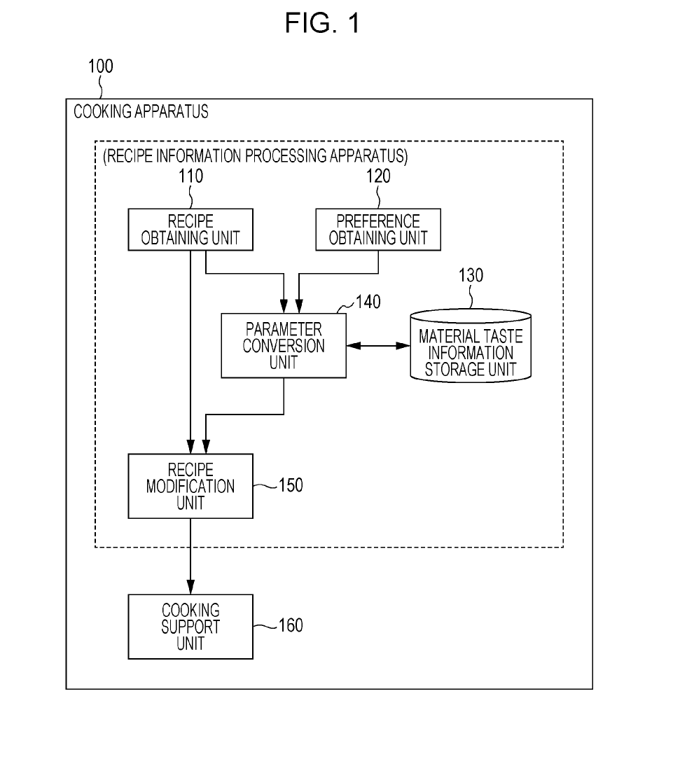

FIG. 1 is a block diagram of a cooking apparatus 100 according to the first embodiment.

As illustrated in FIG. 1, the cooking apparatus 100 includes a recipe obtaining unit 110, a preference obtaining unit 120, a material taste information storage unit 130, a parameter conversion unit 140, a recipe modification unit 150, and a cooking support unit 160. Of the above-mentioned units, the recipe obtaining unit 110 to the recipe modification unit 150 correspond to a recipe information processing apparatus according to the present disclosure.

The recipe obtaining unit 110 obtains recipe information for a dish. In more detail, the recipe obtaining unit 110 accepts selection of one among preset plural sorts of dishes from a user through a user interface, for example. Then, the recipe obtaining unit 110 accesses a memory in which recipe information for the plural sorts of dishes is stored in advance, and obtains the recipe information corresponding to the selected sort of dish. Such a memory may be included in the cooking apparatus 100 or in a server (cloud server) on a communication network. Thereafter, the recipe obtaining unit 110 outputs the obtained recipe information to the parameter conversion unit 140 and the recipe modification unit 150.

It is here assumed that the recipe information contains at least values of cooking parameters that define a manner of cooking. In this embodiment, it is also assumed that the cooking parameters indicate respective amounts (weights or quantities) of materials used for cooking the dish. The materials may include not only seasonings such as salt and pepper, but also foodstuffs such as vegetables and meats. The recipe information may further contain, for example, the names of the materials, processes (details and order) of the cooking, heating temperature, and heating time.

The dish cooked in accordance with the recipe information obtained by the recipe obtaining unit 110 is called a “reference dish” in the following description.

The preference obtaining unit 120 obtains preference information that represents user's preference for the taste (hereinafter referred to as “taste preference”). In more detail, the preference obtaining unit 120 accesses, e.g., a memory that stores preference information for a plurality of dish categories in advance, and obtains the preference information corresponding to the dish category to which the selected dish belongs. Such a memory may be included in the cooking apparatus 100 or in a server (cloud server) on a communication network. Another example of the preference obtaining unit 120 may accumulate in itself the preference information for each of the plural dish categories. Thereafter, the preference obtaining unit 120 outputs the obtained preference information to the parameter conversion unit 140.

Here, the preference information is generated in accordance with subjective evaluation by the user for the reference dish. The subjective evaluation may be made, for example, after the reference dish has actually been served to the user. The preference obtaining unit 120 may accept input of the subjective evaluation by the user for the taste of the reference dish from the user via the user interface. In such a case, the subjective evaluation may be made when the occasion demands.

For example, when the user prefers the fairly salty taste for the reference dish, the preference information provides data indicating that the user prefers the fairly salty taste.

The material taste information storage unit 130 stores material taste information representing a relationship between the cooking parameter, specifically a unit amount of each of the materials of the dish, and a taste vector, which defines the taste, in a state capable of being referred to by the parameter conversion unit 140 described later. A taste vector defining the taste of the dish is determined by respective amounts of the materials of the dish and the material taste information.

Here, the term “taste vector” is a vector in a specific taste space and expresses the taste in a quantized fashion. The taste space is a space defined by a plurality of axes indicating respective intensities of different basic tastes. The basic tastes is plural kinds of tastes serving as bases of the tastes of various dishes and include, for example, six kinds of tastes, i.e., bitter taste, sweet taste, delicious taste, salty taste, sour taste, and astringent taste. In that case, the specific taste space is a six-dimensional space in combination of six axes of, e.g., a bitter taste axis, sweet taste axis, a delicious taste axis, a salty taste axis, a sour taste axis, and an astringent taste axis.

For example, an onion is fairly pungent in a raw state, but it becomes sweet after being subjected to heating. Thus, the taste vector in the taste space may be changed between before and after cooking depending on the kinds of materials. For that reason, the taste vector in anticipation of the taste after the cooking is used here.

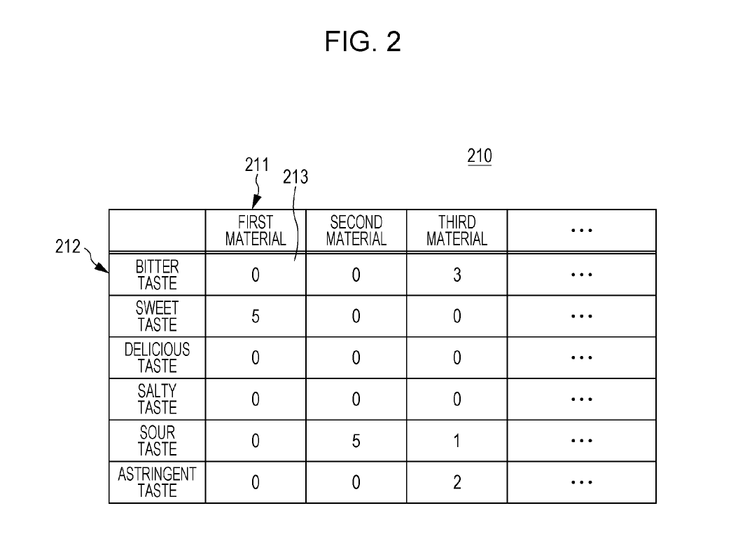

FIG. 2 illustrates one example of the material taste information.

As illustrated in FIG. 2, material taste information 210 describes a material taste vector 213 having components each of which represents intensity of the taste of each basic taste 212 per unit amount (unit weight or unit quantity) of the material for each material 211. In other words, the material taste vector 213 is a vector indicating the taste of each material and the intensity of the taste per unit amount of the relevant material in terms of the above-mentioned taste space.

Thus, the material taste information is information enabling taste components of the reference dish to be obtained in link to the materials when combined with the recipe information that contains the amounts of the materials.

For example, the material taste vector 213 having components of “0, 5, 0, 0, 0, 0”, which represent respective intensities of “bitter taste, sweet taste, delicious taste, salty taste, sour taste, and astringent taste”, is described in link to “first material” of the material type 211. This implies that the material type 211 has the sweet taste with the intensity of “5”.

The parameter conversion unit 140 in FIG. 1 determines, based on the input preference information, details of modification given to the amounts of the materials contained in the input recipe information. In more detail, the parameter conversion unit 140 calculates, based on the material taste information 210 (see FIG. 2) stored in the material taste information storage unit 130, the amount of at least one material (i.e., the value of at least one cooking parameter), which is resulted by modifying the taste of the reference dish (i.e., the components of the taste vector) to be more closely fit to the taste preference of the user. Then, the parameter conversion unit 140 outputs, to the recipe modification unit 150, modification instructing information that indicates the determined details of the modification.

Assume, for example, that the preference information indicates that the user prefers the fairly salty taste and the materials of the reference dish include salt. In such a case, the modification instructing information instructs an increase of a salt amount, for example.

The input modification instructing information enables the recipe modification unit 150 to modify the input recipe information and generates modified recipe information. Stated in another way, the recipe modification unit 150 modifies the amount of at least one material (i.e., the value of at least one cooking parameter) in the recipe information in such a direction that the taste of the reference comes more closely fit to the preference of the user. When the taste of the reference is much the same as the preference of the use, it is not necessary to modify the recipe information. Thereafter, the recipe modification unit 150 outputs the modified recipe information, which has been generated as described above, to the cooking support unit 160.

Assume, for example, that the modification instructing information instructs an increase of the salt amount. In such a case, the recipe modification unit 150 generates the modified recipe information indicating a larger amount of salt than that indicated in the recipe information before being modified, for example.

The cooking support unit 160 supports the cooking in accordance with the input modified recipe information. In more detail, the cooking support unit 160 includes, for example, a display device such as the above-mentioned touch panel display, and a heating device (not illustrated) that is used in a heating process for the cooking. The cooking support unit 160 displays, on the above-mentioned touch panel display, for example, the names and the amounts of the materials, and the processes (details and order) of the cooking, which are contained in the modified recipe information, and it carries out the cooking in accordance with, for example, the heating temperature and the heating time, which are indicated by the modified recipe information.

Speech recognition or gesture recognition may be utilized for the user interface instead of using the touch panel. When a part of the functions of the cooking apparatus 100 exists on the cloud, the display device is not to be used in some cases. A display of a smartphone or a smart TV, for example, operating in link with the function on the cloud may be used instead of the display device.

Though not illustrated, in one example, the cooking apparatus 100 includes a CPU (Central Processing Unit), a storage medium such as a ROM (Read Only Memory), which stores control programs, a working memory such as a RAM (Random Access Memory), and a communication circuit. In such a case, the functions of the above-described components are implemented by the CPU executing the control programs.

The cooking apparatus 100 having the above-described configuration can modify the amount of at least one material, which is indicated by the recipe information, based on the information indicating the taste preference of the user.

### <Manner of Setting Dish Category>

A manner of setting the above-described dish category will be described below.

Even for the same user, the taste preference may be different depending on dishes. For example, some user likes the fairly salty taste for curried rice, but likes the fairly sweet taste for rice with hashed meat. Accordingly, it may be practical to obtain the preference information and to modify the amount of at least one material (i.e., to generate the modification instructing information) per dish category.

The dish category is obtained by classifying many sorts of dishes into groups in each of which the taste preference is almost similar for the same user. In other words, when the tastes of many sorts of dishes are grouped into clusters in the taste space, one dish category corresponds to each of the clusters, for example.

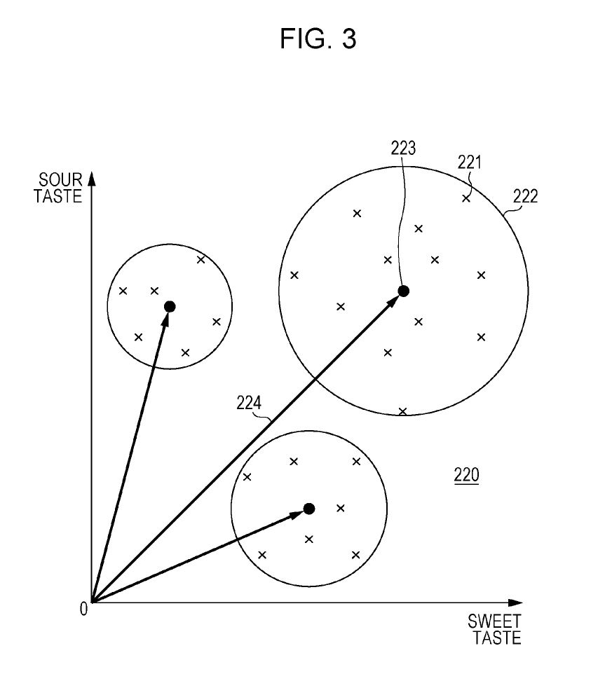

FIG. 3 is a graph to explain the dish category.

The tastes of dishes are different depending on ways of cooking and exist infinitely. In view of such a point, a taste analysis process is performed on each of many dishes to detect respective intensities of basic tastes of each dish by employing a taste analysis apparatus (not illustrated), for example. The taste analysis process can be practiced, for example, by executing a process of outputting information indicating individual taste intensities through a neuron circuit network based on output values from a group of taste sensors, the process being disclosed in Japanese Unexamined Patent Application Publication No. 3-163351. As a result of the taste analysis process, the tastes of the many dishes are mapped on a taste space 220 as denoted by a marks (x) 221, by way of example, in FIG. 3.

It is to be noted that FIG. 3 illustrates, among various taste spaces used in the cooking apparatus 100, one two-dimensional taste space defined by the sweet taste axis and the sour taste axis.

The taste analysis apparatus groups the mapped many tastes into clusters by employing the known clustering method, e.g., the k-means method. Then, the taste analysis apparatus defines a plurality of clusters 222 denoted, for example, by circles in FIG. 3, and assigns an identifier (e.g., a cluster number) for each dish category. Moreover, the taste analysis apparatus defines a centroid 223 of each cluster 222 as the reference taste of dishes that belong to the corresponding dish category, and obtains, as the reference taste vector, a vector 224 representing the relevant reference taste in the taste space 220. One cluster 222 may include different sorts of dishes, such as curried rise, curried noodles, and mabo tofu (bean curd in a spicy sauce with hashed meats).

The reference taste (reference taste vector) is obtained per dish category. The above-described reference dish is assumed to have the same or similar taste as or to the reference taste (reference taste vector). Accordingly, the modified recipe information more closely fit to the taste preference of the user can be obtained with high accuracy by employing the preference information that indicates the user's evaluation on the taste of the reference dish.

When new recipe information is created, a reference taste vector for the new recipe information may be determined by selecting one of the centroids 223 of the existing clusters 222. In such a case, a vector representing the taste of a dish obtained with the new recipe information is determined from, for example, material taste vectors of individual materials of the dish and amounts of the materials, and the centroid 223 of the cluster 222 having the vector closest to the determined vector is selected.

The cooking apparatus 100 or another apparatus may perform the above-described processes of grouping the dish tastes into clusters and determine the reference taste per cluster.

### <Operation of Cooking Apparatus>

The operation of the cooking apparatus 100 will be described below.

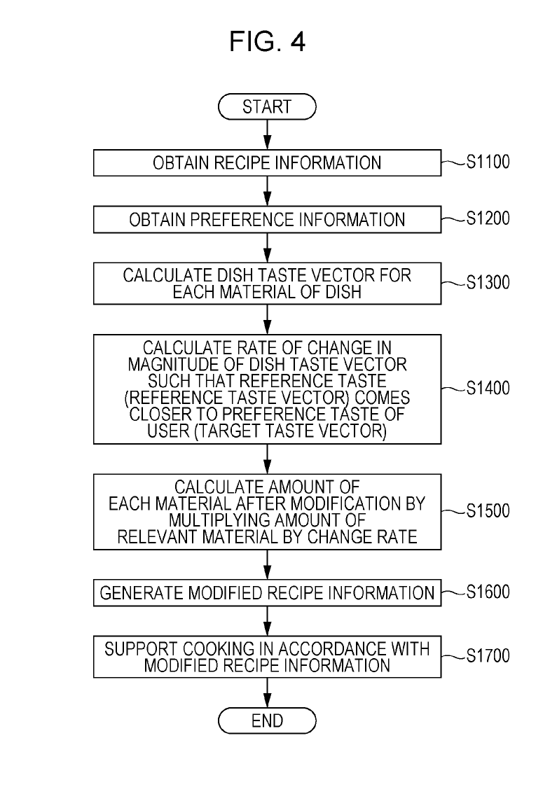

FIG. 4 is a flowchart illustrating one example of the operation of the cooking apparatus 100.

In step S1100, the recipe obtaining unit 110 obtains the recipe information of a dish. For example, when “curried rice” is designated as the dish to be cooked, the recipe information for the curried rice is obtained.

In step S1200, the preference obtaining unit 120 obtains the preference information. The preference obtaining unit 120 obtains, for example, the preference information generated in accordance with the subjective evaluation by the user, which has been made on the reference dish. Then, the preference obtaining unit 120 determines, based on the obtained preference information, a target taste change rate vector having components that indicate rates of changes to be applied to individual basic tastes of the reference dish. In other words, the target taste change rate vector is a vector representing the rates of the changes, which are to be applied to the tastes of the reference dish, in terms of the taste space.

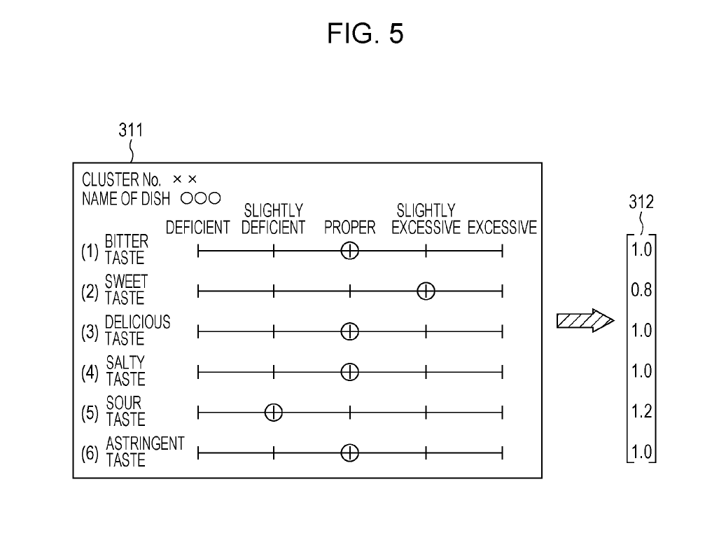

FIG. 5 illustrates examples of the preference information and the target taste change rate vector.

As illustrated in FIG. 5, preference information 311 contains, e.g., five levels of choices, i.e., “deficient”, “slightly deficient”, “proper”, “slightly excessive” and “excessive”, for each of the basic tastes in link to the cluster number and the name of the dish. Values of “1.4”, “1.2”, “1.0”, “0.8”, and “0.6” are previously set, as values to be set to the corresponding components of the target taste change rate vector, for the choices of “deficient”, “slightly deficient”, “proper”, “slightly excessive” and “excessive”, respectively.

It is here assumed, for example, that “slightly excessive” is chosen for the “sweet taste”, “slightly deficient” is chosen for the “sour taste”, and “proper” is chosen for the other basic tastes, as indicated by the preference information 311 in FIG. 5. In such a case, the preference obtaining unit 120 determines, for example, the target taste change rate vector 312 having the components of “1.0, 0.8, 1.0, 1.0, 1.2, 1.0”, which indicate the rates of the changes to be applied to “bitter taste, sweet taste, delicious taste, salty taste, sour taste, and astringent taste”, respectively, in accordance with the above-described preset correspondence.

A method of determining (generating) the target taste change rate vector 312 is not limited to the example described above. As another example, when the user eats a dish having the taste similar to the reference taste (i.e., the centroid 223 of the cluster 222, see FIG. 3) of the corresponding dish category, the user may actually increase or decrease the amount of some material (e.g., the amount of a seasoning), and may specify a target taste vector that represents the preference taste of the user in the taste space. Then, the target taste change rate vector may be calculated by dividing the target taste vector by the reference taste vector for each of the basic tastes. As a result, the target taste change rate vector 312 can be set more accurately.

In step S1300 of FIG. 4, the parameter conversion unit 140 calculates a dish taste vector based on both the material taste information 210 (see FIG. 2) for each of materials of the reference dish and the amount of each of the materials of the dish. Here, the dish taste vector is expressed by a value representing, for each of taste components of the dish, the intensity of the taste component in the above-described specific space. For example, the parameter conversion unit 140 calculates, as the dish taste vector, a vector obtained by multiplying the value set for the material 211 (see FIG. 2) by the amount of the relevant material for each of the materials. In other words, the dish taste vector based on the reference taste corresponds to the reference taste vector, and the dish taste vector modified to be fit to the preference taste of the user corresponds to the target taste vector.

In step S1400, the parameter conversion unit 140 calculates a rate of change in magnitude of the dish taste vector (reference taste vector) (hereinafter referred to as a “material amount change rate”) or a taste differential vector such that the reference taste (reference taste vector) comes closer to the preference taste of the user (i.e., the target taste vector). Here, the taste differential vector is a differential vector representing a difference between the reference taste vector (see the vector 224 in FIG. 3) and the target taste vector representing the preference taste of the user in the taste space.

When the target taste change rate vector 312 is obtained as the preference information as described above, the parameter conversion unit 140 may define, as the material amount change vector, a ratio of the magnitude of a vector, which is resulted from multiplying the dish taste vector by the target taste change rate vector 312, to the magnitude of the dish taste vector. Alternatively, when the target taste vector is obtained as the preference information, the parameter conversion unit 140 may calculate the taste differential vector from the difference between the reference taste vector and the target taste vector.

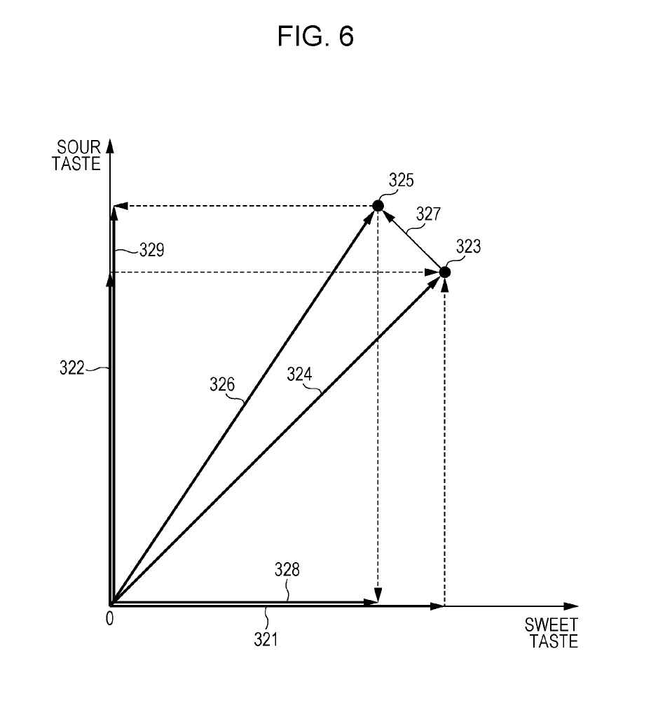

FIG. 6 is a graph to explain a relationship among various vectors.

For convenience of explanation, it is here assumed that materials related to the taste of the dish are the first material having the sweet taste and the second material having the sour taste, those materials being illustrated in FIG. 2. It is also assumed that the preference information is represented by the target taste change rate vector 312 having the components of “1.0, 0.8, 1.0, 1.0, 1.2, 1.0”, which is illustrated in FIG. 5.

As illustrated in FIG. 6, adding a dish taste vector 321 of the first material and a dish taste vector 322 of the second material results in a reference taste vector 324 representing taste 323 of the reference dish. For example, a target taste vector 326 representing preference taste 325 of the user is given by multiplying the reference taste vector 324 by target taste change rate vectors (here a sweet taste component: 0.8 and a sour taste component: 1.2). Alternatively, the target taste vector 326 representing the preference taste 325 of the user is given by adding a taste differential vector 327 to the reference taste vector 324.

Making the reference taste (reference taste vector 324) closer to the preference taste of the user (i.e., the target taste vector 326) corresponds to, for example, multiplication of the reference taste vector 324 by the target taste change rate vectors or addition of the taste differential vector 327 to the reference taste vector 324. Furthermore, the multiplication of the reference taste vector 324 by the target taste change rate vectors corresponds to (1) calculation of a modified dish taste vector 328 of the first material by multiplying the dish taste vector 321 of the first material by the corresponding target taste change rate vector and (2) calculation of a modified dish taste vector 329 of the second material by multiplying the dish taste vector 322 of the second material by the corresponding target taste change rate vector. The taste differential vector 327 has a first vector of a sweet taste axis and a second vector of a sour taste axis. Moreover, the addition of the taste differential vector 327 to the reference taste vector 324 corresponds to (1) calculation of the modified dish taste vector 328 of the first material by adding the first vector to the dish taste vector 321 of the first material, (2) calculation of the modified dish taste vector 329 of the second material by adding the second vector to the dish taste vector 322 of the second material, and (3) addition of the modified dish taste vector 328 and the modified dish taste vector 329.

A ratio of the magnitude of the modified dish taste vector 328 of the first material to the magnitude of the dish taste vector 321 of the first material corresponds to a rate of change in amount to be applied to the first material. A ratio of the magnitude of the modified dish taste vector 329 of the second material to the magnitude of the dish taste vector 322 of the second material corresponds to a rate of change in amount to be applied to the second material. Furthermore, the above-mentioned ratios are equivalent to respective components of the target taste change rate vectors.

For some type of material, the material amount change rate may be “1.0”, namely a value indicating no change may be calculated. Moreover, the parameter conversion unit 140 may modify the reference taste vector to come closer to the target taste vector by increasing or decreasing the magnitude of each reference taste vector in descending order from the material for which the magnitude of the reference taste vector is maximal.

In step S1500, the parameter conversion unit 140 calculates an amount of each material after the modification by multiplying the amount of the relevant material by the material amount change rate (i.e., the change rate of the magnitude of the dish taste vector) of the relevant material. Alternatively, the parameter conversion unit 140 may determine an amount of each material after the modification by calculating the amount of the relevant material, which corresponds to the target taste vector resulting from adding the taste differential vector to the dish taste vector (reference taste vector).

In step S1600, the recipe modification unit 150 modifies the recipe information and generates the modified recipe information by rewriting the amounts of the materials in the recipe information to the modified amounts of the materials. The recipe modification unit 150 may further modify another cooking parameter, e.g., the heating time, corresponding to the modification of the amount of the material. In such a case, the recipe modification unit 150 refers to a table that previously describes a correspondence relationship between the modification of the amount of the material and the modification of the other cooking parameter. Details of those modifications may be determined by the parameter conversion unit 140.

However, for the purpose of making the temperature of the reference dish of which taste has been evaluated by the user and the temperature of the dish cooked by the cooking apparatus 100 come close to each other, a modification to change the finishing temperature of the dish is not to be performed in some cases.

In step S1700, the cooking support unit 160 supports the cooking in accordance with the modified recipe information and then ends the series of processes.

With the operation described above, the cooking apparatus 100 can determine, based on the information indicating the taste preference of the user, details of the modification to be applied to the amounts of the materials, which are denoted in the recipe information, such that the cooked dish is more closely fit to the taste preference of the user.

As described above, since the cooking apparatus 100 according to the first embodiment modifies the amounts of the materials, which are denoted in the recipe information, based on the information indicating the taste preference of the user, it can automatically generate the recipe information that is more closely fit to the taste preference of the user. As a result, the cooking apparatus 100 can present the dish fit to the taste preference of the user.

### Second Embodiment

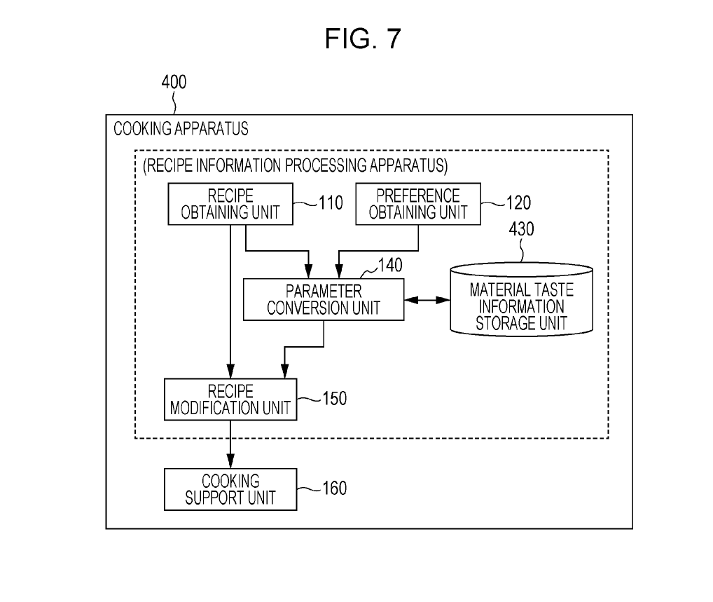

A second embodiment will be described below. A cooking apparatus 400 (FIG. 7) according to the second embodiment includes a recipe obtaining unit 110, a preference obtaining unit 120, a material taste information storage unit 430, a parameter conversion unit 140, a recipe modification unit 150, and a cooking support unit 160. In the second embodiment, it is assumed that the recipe information obtained by the recipe obtaining unit 110 contains a cooking parameter representing a heating time. As in the first embodiment, the recipe information may contain the names of materials used in cooking the dish, processes (details and order) of the cooking, and so on. It is also assumed that the preference information obtained by the preference obtaining unit 120 contains an axis indicating “fragrance” in addition to the information indicating the taste vectors in the first embodiment.

The material taste information storage unit 430 stores not only the material taste information indicating the relationship, used in the first embodiment, between the cooking parameter, specifically a unit amount of each of the materials of the dish, and the taste vector defining the taste, but also additional material taste information indicating a relationship between a cooking step represented by an additional cooking parameter and a vector representing fragrance. Those relationships are stored in a state capable of being referred by the parameter conversion unit 140.

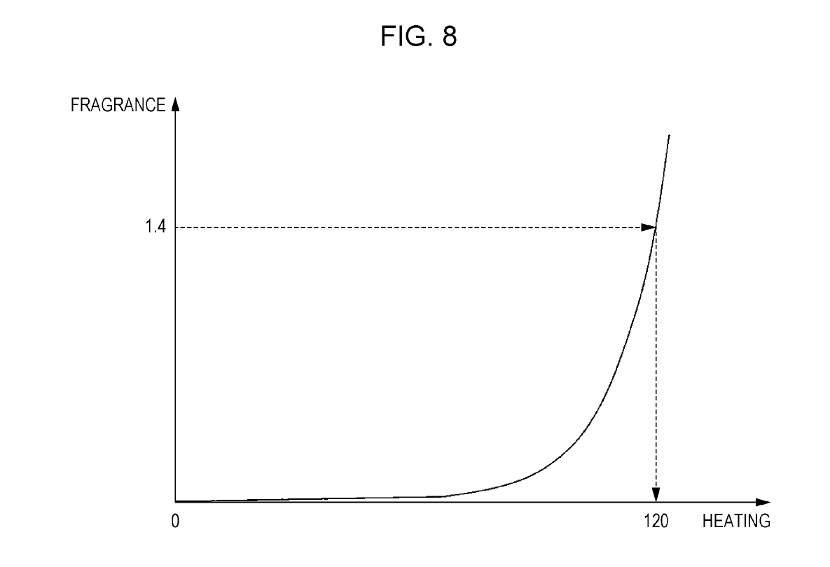

In the second embodiment, for example, a heating time representing one type of cooking steps is used as the additional cooking parameter. In such a case, the material taste information storage unit 430 stores a correlation between the heating time and fragrance, e.g., a correlation that the vector representing fragrance has a larger magnitude as the heating time is prolonged, in the form of a table or a function. FIG. 8 is a graph depicting the correlation between the heating time and fragrance in the second embodiment. From the correlation depicted in FIG. 8, it can be recognized how fragrance is changed when the heating time is changed.

The input preference information enables the parameter conversion unit 140 to determine specifics of the modification to be made on the heating time contained in the input recipe information. In the second embodiment, the parameter conversion unit 140 modifies the amounts of the materials, and further modifies the heating time based on the above-described correlation, stored in the material taste information storage unit 430, such that the cooked dish is more closely fit to the preference of the user (i.e., the fragrance preferred by the user). Thereafter, the parameter conversion unit 140 outputs the modification instructing information, which indicates the determined specifics of the modification, to the recipe modification unit 150.

Assume here, for example, that the preference information indicates that the user prefers more fragrant scent, and the stored correlation indicates that the fragrance increases as the heating time is prolonged. In such a case, the modification instructing information instructs, for example, that the heating time is prolonged.

The input modification instructing information enables the recipe modification unit 150 to modify the input recipe information and generate the modified recipe information. More specifically, the recipe modification unit 150 modifies the heating time in the recipe information in a direction in which the taste of the reference dish comes closer to the preference of the user. Thereafter, the recipe modification unit 150 outputs the modified recipe information, which has been generated as described above, to the cooking support unit 160.

Assume here, for example, that the modification instructing information instructs prolongation of the heating time. In such a case, the modified recipe information instructs a longer time, as the heating time, than that set in the recipe information before the modification.

The cooking support unit 160 includes, as in the first embodiment, a display device such as a touch panel display, and a heating device that is used in a heating process for the cooking. Furthermore, as in the first embodiment, the cooking support unit 160 displays, on the touch panel display, the names and the amounts of the materials, the processes (details and order) of the cooking, etc., which are contained in the modified recipe information, and it carries out the cooking in accordance with the heating temperature, the heating time, etc., which are indicated by the modified recipe information. At that time, the cooking is performed for a heating time prolonged to increase the fragrance.

### <Manner of Setting Dish Category>

A manner of setting the dish category is similar to that in the first embodiment. Namely, many sorts of dishes are classified into groups in each of which the taste preference is almost similar for the same user. In the second embodiment, however, the taste space is defined by not only the above-described axes or taste vectors (representing the “bitter taste”, the “sweet taste”, the “delicious taste”, the “salty taste”, the “sour taste”, and the “astringent taste”), but also an axis or a vector representing the fragrance. Thus, many sorts of dishes are grouped into clusters in the taste space defined as mentioned above. Many mapped tastes are clustered by employing the known clustering method, such as the k-means method, as in the first embodiment.

The reference taste (reference taste vector) is also defined in the taste space added with the axis representing the “fragrance”, and a manner of determining the reference taste (reference taste vector) is similar to that described in the first embodiment.

### <Operation of Cooking Apparatus>

The operation of the cooking apparatus 400 will be described below.

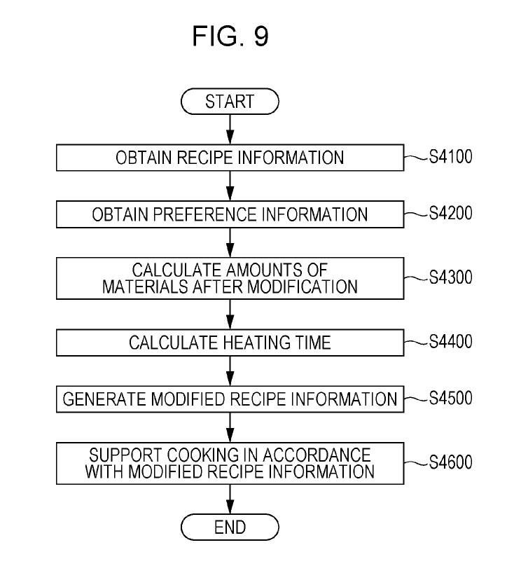

FIG. 9 is a flowchart illustrating one example of the operation of the cooking apparatus 400.

In step S4100, the recipe obtaining unit 110 obtains the recipe information of a dish. For example, when “ginger pork” is designated as the dish to be cooked, the recipe information for the ginger pork is obtained.

In step S4200, the preference obtaining unit 120 obtains the preference information. The preference obtaining unit 120 obtains, for example, the preference information generated in accordance with the subjective evaluation by the user, which has been made on the reference dish. Then, the preference obtaining unit 120 determines target taste change rate vectors for individual basic tastes of the reference dish as in the first embodiment. At that time, the target taste change rate vectors are determined in terms of the taste space (taste vectors) including the “fragrance” in addition to the “bitter taste”, the “sweet taste”, the “delicious taste”, the “salty taste”, the “sour taste”, and the “astringent taste”.

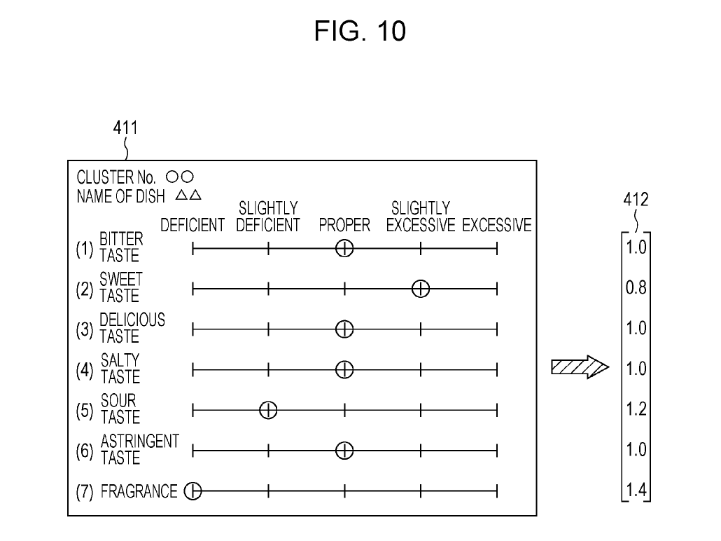

FIG. 10 illustrates examples of the preference information and the target taste change rate vector.

As illustrated in FIG. 10, preference information 411 contains, e.g., five levels of choices as in the first embodiment, i.e., “deficient”, “slightly deficient”, “proper”, “slightly excessive” and “excessive”, for each of the basic tastes in link to the cluster number and the name of the dish. However, the basic tastes include the “fragrance” in addition to the “bitter taste”, the “sweet taste”, the “delicious taste”, the “salty taste”, the “sour taste”, and the “astringent taste”.

It is here assumed, for example, that “slightly excessive” is chosen for the “sweet taste”, “slightly deficient” is chosen for the “sour taste”, “proper” is chosen for the “bitter taste”, the “delicious taste”, the “salty taste”, and the “astringent taste”, and “deficient” is chosen for the “fragrance”, as indicated by the preference information 411 in FIG. 10. In such a case, the preference obtaining unit 120 determines, for example, the target taste change rate vector 412 having the components of “1.0, 0.8, 1.0, 1.0, 1.2, 1.0, 1.4”, which indicate the rates of the changes to be applied to “bitter taste, sweet taste, delicious taste, salty taste, sour taste, astringent taste, and fragrance”, respectively, in accordance with the above-described preset correspondence.

A method of determining (generating) the target taste change rate vector 412 is not limited to the example described above. As another example, as in the first embodiment, when the user eats a dish having the taste similar to the reference taste of the corresponding dish category, the user may actually increase or decrease the amount of some material (e.g., the amount of a seasoning), and may specify a target taste vector that represents the preference taste of the user in the taste space. Then, the target taste change rate vector may be calculated by dividing the target taste vector by the reference taste vector for each of the basic tastes. As a result, the target taste change rate vector 412 can be set more accurately.

In step S4300 of FIG. 9, the parameter conversion unit 140 calculates the material amount change rate for each of the “bitter taste”, the “sweet taste”, the “delicious taste”, the “salty taste”, the “sour taste”, and the “astringent taste” other than the “fragrance”, and finally calculates the amounts of the individual materials after the modification in a similar manner to that in the first embodiment.

In step S4400, the parameter conversion unit 140 checks the material taste information indicating the correlation between the heating time (cooking parameter) and the fragrance vector by referring to the material taste information storage unit 430, and determines the heating time. It is here assumed that the material taste information storage unit 430 stores the information indicating the correlation between the heating time and the fragrance, such as illustrated in FIG. 8. In the second embodiment, the fragrance is to be increased to a level 1.4 times higher than that set in the target taste change rate vector 412 for the purpose of making the cooked dish more closely fit to the taste preference of the user. As seen from the correlation illustrated in FIG. 8, the heating time is to be set to 120 sec in order to increase the fragrance 1.4 times. Thus, the parameter conversion unit 140 sets the heating time to 120 sec.

In step S4500, the recipe modification unit 150 modifies the recipe information and generates the modified recipe information by rewriting the amounts of the materials and the heating time in the recipe information to the modified values.

In step S4600, the cooking support unit 160 supports the cooking in accordance with the modified recipe information. In the heating process, the heating is performed for the modified heating time. Thereafter, the cooking support unit 160 ends the series of processes.

The operation described above enables the cooking apparatus 400 to determine, based on the information indicating the taste preference of the user, details of the modification to be applied to the amounts of the materials and the heating time, which are denoted in the recipe information, such that the cooked dish is more closely fit to the taste preference of the user.

As described above, since the cooking apparatus 400 according to this embodiment modifies the amounts of the materials and the heating time, which are denoted in the recipe information, based on the information indicating the taste preference of the user, it can automatically generate the recipe information that is more closely fit to the taste preference of the user. As a result, the cooking apparatus 400 can present the dish more closely fit to the taste preference of the user.

In the two embodiments described above, some of the components of the cooking apparatus 100 (400), such as the material taste information storage unit 130 (430), may be disposed in a remote place, e.g., in a server on a communication network.

While the cooking parameters to be modified in the present disclosure are the amount of the material and the heating time in the two embodiments described above, the cooking parameters are not limited to those examples. The cooking parameter to be modified may be selected from other various parameters affecting the state of the cooked dish, e.g., a pressure, a cooking time, an output setting of a microwave oven, a heating temperature, a cooling temperature, an amount of steam, a degree of mixing, a degree of crushing, a degree of kneading, a degree of fermentation, and a degree of ingredient change. Moreover, the information indicating preference may further optionally contain, in addition to the above-described information representing the tastes given as the “bitter taste”, the “sweet taste”, the “delicious taste”, the “salty taste”, the “sour taste”, and the “astringent taste”, other various parameters affecting the state of the cooked dish, e.g., scent such as “fragrance”, a temperature of the dish, texture (including hardness, resiliency, and size of foodstuffs), feeling when swallowing, stimulus (including pungent taste, carbonation, and a degree of sparkling), and appearance of the dish, such as colors.

The recipe information processing apparatus according to the present disclosure includes a recipe obtaining unit that obtains recipe information for a dish, a preference obtaining unit that obtains preference information for a user, and a recipe modification unit that, based on the obtained preference information, modifies a value of a cooking parameter, which defines a manner of cooking, to provide modified recipe information, the cooking parameter value being included in the obtained recipe information.

In the recipe information processing apparatus described above, the preference information may be information indicating taste preference of the user, and the recipe modification unit may modify the value of the cooking parameter in a direction in which taste of the dish is more closely fit to the taste preference indicated by the preference information.

The recipe information processing apparatus described above may further include a material taste information storage unit that stores material taste information indicating a relationship between the cooking parameter and a taste vector that defines taste, and a parameter conversion unit that, based on the stored material taste information, calculates the value of the cooking parameter that is to be taken when a value of the taste vector is modified to make the taste of the dish more closely fit to the taste preference, wherein the recipe modification unit may modify the value of the cooking parameter into the calculated value.

In the recipe information processing apparatus described above, the cooking parameter may be an amount of a material of the dish, the material taste information may be a material taste vector representing taste of the material and intensity of the taste per unit amount of the material, the preference information may indicate a taste differential vector representing a difference between a reference taste vector representing the taste of the dish and a target taste vector representing preference taste of the user, and the parameter conversion unit may calculate an amount of the material after the modification based on both the amount of the material and the taste differential vector.

In the recipe information processing apparatus described above, the cooking parameter may be an amount of a material of the dish, the preference information may indicate a target taste change rate vector representing a rate of change to be applied to the taste of the dish, and the parameter conversion unit may set a value, which is obtained by multiplying the amount of the material by the target taste change rate vector, as an amount of the material after the modification.

In the recipe information processing apparatus described above, the taste vector may be defined in terms of a space having a plurality of axes corresponding to respective intensities of different basic tastes.

In the recipe information processing apparatus described above, the dish may belong to one of a plurality of preset dish categories, the target taste vector may be linked to one of the plural dish categories, and the parameter conversion unit may calculate the amount of the material for each of the dish categories.

In the recipe information processing apparatus described above, the dish categories may correspond to clusters that are obtained by grouping a plurality of dish tastes per cluster, and the target taste vector may be generated for each of the clusters in accordance with taste evaluation made by the user on a dish having taste that corresponds to a centroid of the relevant cluster.

In the recipe information processing apparatus described above, the preference obtaining unit may obtain and accumulate the preference information for each of the plural dish categories.

In the recipe information processing apparatus described above, the cooking parameter may correspond to a cooking step of the dish, the material taste information is information indicating a relationship between change of the cooking step and change of taste, the preference information may indicate a taste differential vector representing a difference between a reference taste vector representing the taste of the dish and a target taste vector representing preference taste of the user, and the parameter conversion unit may determine the cooking step after the modification based on both the relationship between change of the cooking step and change of taste and the taste differential vector.

In the recipe information processing apparatus described above, the taste vector may be defined in terms of a space having a plurality of axes corresponding to respective intensities of different basic tastes.

In the recipe information processing apparatus described above, the dish may belong to one of a plurality of preset dish categories, the target taste vector may be linked to one of the plural dish categories, and the parameter conversion unit may calculate the amount of the material for each of the dish categories.

In the recipe information processing apparatus described above, the dish categories may correspond to clusters that are obtained by grouping a plurality of dish tastes per cluster, and the target taste vector may be generated for each of the clusters in accordance with taste evaluation made by the user on a dish having taste that corresponds to a centroid of the relevant cluster.

In the recipe information processing apparatus described above, the preference obtaining unit may obtain and accumulate the preference information for each of the plural dish categories.

A cooking apparatus according to the present disclosure includes a recipe obtaining unit that obtains recipe information for a dish, a preference obtaining unit that obtains preference information for a user, a recipe modification unit that, based on the obtained preference information, modifies a value of a cooking parameter, which defines a manner of cooking, to provide modified recipe information, the value of the cooking parameter being included in the obtained recipe information, and a cooking support unit that supports the cooking in accordance with the modified recipe information.

A recipe information processing method according to the present disclosure includes obtaining recipe information for a dish, obtaining preference information for a user, and based on the obtained preference information, modifying a value of a cooking parameter, which defines a manner of cooking, to provide modified recipe information, the value of the cooking parameter being included in the obtained recipe information.

The present disclosure is usefully practiced as the recipe information processing apparatus, the cooking apparatus, and the recipe information processing method, which can provide dishes fit to preferences of users.

What is claimed is:

1. A recipe information processing apparatus, comprising:
a recipe obtaining unit that obtains recipe information for a dish;
a preference obtaining unit that obtains preference information for a user; and
a recipe modification unit that, based on the obtained preference information, modifies a value of a cooking parameter, which defines a manner of cooking, to provide modified recipe information, the cooking parameter value being included in the obtained recipe information.

2. The recipe information processing apparatus according to claim 1, wherein the preference information is information indicating taste preference of the user, and
the recipe modification unit modifies the value of the cooking parameter in a direction in which taste of the dish is more closely fit to the taste preference indicated by the preference information.

3. The recipe information processing apparatus according to claim 2, further comprising:
a material taste information storage unit that stores material taste information indicating a relationship between the cooking parameter and a taste vector that defines taste; and
a parameter conversion unit that, based on the stored material taste information, calculates the value of the cooking parameter that is to be taken when a value of the taste vector is modified to make the taste of the dish more closely fit to the taste preference,
wherein the recipe modification unit modifies the value of the cooking parameter into the calculated value.

4. The recipe information processing apparatus according to claim 3, wherein the cooking parameter is an amount of a material of the dish,
the material taste information is a material taste vector representing taste of the material and intensity of the taste per unit amount of the material,
the preference information indicates a taste differential vector representing a difference between a reference taste vector representing the taste of the dish and a target taste vector representing preference taste of the user, and
the parameter conversion unit calculates an amount of the material after the modification based on both the amount of the material and the taste differential vector.

5. The recipe information processing apparatus according to claim 3, wherein the cooking parameter is an amount of a material of the dish,
the preference information indicates a target taste change rate vector representing a rate of change to be applied to the taste of the dish, and
the parameter conversion unit sets a value, which is obtained by multiplying the amount of the material by the target taste change rate vector, as an amount of the material after the modification.

6. The recipe information processing apparatus according to claim 3, wherein the taste vector is defined in terms of a space having a plurality of axes corresponding to respective intensities of different basic tastes.

7. The recipe information processing apparatus according to claim 4, wherein the dish belongs to one of a plurality of preset dish categories,
the target taste vector is linked to one of the plural dish categories, and
the parameter conversion unit calculates the amount of the material for each of the dish categories.

8. The recipe information processing apparatus according to claim 7, wherein the dish categories correspond to clusters that are obtained by grouping a plurality of dish tastes per cluster, and
the target taste vector is generated for each of the clusters in accordance with taste evaluation made by the user on a dish having taste that corresponds to a centroid of the relevant cluster.

9. The recipe information processing apparatus according to claim 7, wherein the preference obtaining unit obtains and accumulates the preference information for each of the plural dish categories.

10. The recipe information processing apparatus according to claim 3, wherein the cooking parameter corresponds to a cooking step of the dish,
the material taste information is information indicating a relationship between change of the cooking step and change of taste,
the preference information indicates a taste differential vector representing a difference between a reference taste vector representing the taste of the dish and a target taste vector representing preference taste of the user, and
the parameter conversion unit determines the cooking step after the modification based on both the relationship between change of the cooking step and change of taste and the taste differential vector.

11. The recipe information processing apparatus according to claim 10, wherein the taste vector is defined in terms of a space having a plurality of axes corresponding to respective intensities of different basic tastes.

12. The recipe information processing apparatus according to claim 10, wherein the dish belongs to one of a plurality of preset dish categories,
the target taste vector is linked to one of the plural dish categories, and
the parameter conversion unit calculates the amount of the material for each of the dish categories.

13. The recipe information processing apparatus according to claim 10, wherein the dish categories correspond to clusters that are obtained by grouping a plurality of dish tastes per cluster, and
the target taste vector is generated for each of the clusters in accordance with taste evaluation made by the user on a dish having taste that corresponds to a centroid of the relevant cluster.

14. The recipe information processing apparatus according to claim 10, wherein the preference obtaining unit obtains and accumulates the preference information for each of the plural dish categories.

15. A cooking apparatus comprising:
a recipe obtaining unit that obtains recipe information for a dish;
a preference obtaining unit that obtains preference information for a user;
a recipe modification unit that, based on the obtained preference information, modifies a value of a cooking parameter, which defines a manner of cooking, to provide modified recipe information, the value of the cooking parameter being included in the obtained recipe information; and
a cooking support unit that supports the cooking in accordance with the modified recipe information.

16. A recipe information processing method comprising:
obtaining recipe information for a dish;
obtaining preference information for a user; and
based on the obtained preference information, modifying a value of a cooking parameter, which defines a manner of cooking, to provide modified recipe information, the value of the cooking parameter being included in the obtained recipe information.
